(19) United States
(12) Patent Application Publication
(10) Pub. No.: US 2011/0112891 A1
(43) Pub. Date: May 12, 2011

(54) Systems and methods for providing business rankings

(76) Inventors: John Alber, Highland, IL (US); Chris Emerson, O'Fallon, MO (US)

(21) Appl. No.: 12/590,404

(22) Filed: Nov. 6, 2009

(51) Int. Cl. G06Q 10/00; G06F 17/30; G06Q 30/00; G06F 19/00

(52) U.S. Cl. 705/7.42; 707/723; 705/32; 700/91; 707/802; 707/E17.044; 707/748

(57) ABSTRACT

The invention provides one or more databases that store information relating to professional service, such as legal services, accounting services, or the like. In one embodiment, the invention contemplates one or more databases containing accounting information, and one or more databases containing human resource and staffing information. The databases used herein, may be populated with data derived from one or more accounting systems, docketing systems, timekeeper systems, and the like. A software program may be used to access information from the one or more databases to generate statistics and other metrics about a lawyer's performance. In another embodiment, databases and software may be used to generate performance metrics regarding a baseball player's performance, or another individual performance.

### FIELD OF THE INVENTION

This invention relates to systems and methods for providing business rankings, namely, providing a system and method for collecting, calculating and displaying different ranking criteria, such as billing and other information, relating to professional services and the like.

### BACKGROUND OF THE INVENTION

In many professional practices, it is helpful to be able to compare one professional's performance against the performance of his peers. Because certain professional practices involve a number of different metrics from which a professional can be evaluated, often it is difficult to readily compare and analyze one person's performance. Often, a professional must consult multiple charts, statistics and reports in order to have a complete understanding of his performance. It is therefore helpful to have a single informational source that provides professionals with a quick and deeper understanding of their performance and the factors affecting their performance, so that they may readily ascertain areas for improvement and growth.

Accordingly, systems and methods are needed to collect data and information about professional services, to tabulate the data and generate relevant statistics and metrics, and to present the relevant statistics and metrics in a format that provides clarity regarding both performance and areas for improvement.

### SUMMARY OF INVENTION

The invention provides one or more databases that store information relating to professional services. For example, for a law practice, the invention contemplates one or more databases containing accounting information, and one or more databases containing human resource and staffing information. The databases used herein, may be populated with data derived from one or more accounting systems, docketing systems, timekeeper systems, and the like. A software program may be used to access information from the one or more databases to generate statistics and other metrics about a lawyer's performance. The software program may be used to generate an easily understandable report that relates the lawyer's performance to his peers and shows areas for improvement.

In one embodiment of the invention, the databases and programs described herein can be used to generate a representation of relative performance measurements, and to rank and chart one or more people in a population based upon these performance measurements. The invention contemplates the use of performance measurements of any kind. For example, performance measurements may relate to professional services (such as, for example, a firm's collections, total hours billed, hours billed per professional, professional billing rates, matter/timekeeper roles, and general ledger costs.) Performance measurements may also relate to sport statistics, such as, batting statistics, fielding statistics, pitching statistics, or other player statistics (for example, statistics relating to football, basketball, hockey, soccer, and the like). Performance measurements can also relate to statistics for any other type of profession and/or performance indicators as may be contemplated by one skilled in the art.

### BRIEF DESCRIPTION OF THE DRAWINGS

The invention will be better understood from a reading of the following detailed description, taken in conjunction with the accompanying Figures in the drawings in which:

FIG. 1 illustrates a block diagram of an exemplary computerized system and method for analyzing financial data related to professional services;

FIG. 2 illustrates a flow chart of an exemplary extraction and aggregation method for building a system database;

FIG. 3 illustrates an exemplary flow chart illustrating a method for determining timekeeper cost per hour;

FIG. 4 illustrates an exemplary octagon report;

FIG. 5 illustrates an exemplary flow chart for calculating Relationship Collections;

FIG. 6 illustrates an exemplary flow chart for calculating Responsible Collections;

FIG. 7 illustrates another exemplary flow chart for calculating Originating Collections;

FIG. 8 illustrates another exemplary flow chart for calculating Billable Hours;

FIG. 9 illustrates another exemplary flow chart for calculating Leverage;

FIG. 10 illustrates another exemplary flow chart for calculating Margin per Partner Hour;

FIG. 11 illustrates another exemplary flow chart for calculating billing speed;

FIG. 12 illustrates another exemplary flow chart for generating an octagon report;

FIG. 13 illustrates a block diagram of an exemplary computerized system and method for analyzing statistics related to professional baseball players;

FIG. 14 illustrates an exemplary flow chart for generating a dodecagon report;

FIG. 15 illustrates an exemplary dodecagon report comparing professional baseball players.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Furthermore, the terms “include,” “have,” and any variations thereof, are intended to cover a non-exclusive inclusion, such that a process, method, article, or apparatus that comprises a list of elements is not necessarily limited to those elements, but may include other elements not expressly listed or inherent to such process, method, article, or apparatus.

### DETAILED DESCRIPTION OF THE DRAWINGS AND EXAMPLES OF EMBODIMENTS

The detailed description of exemplary embodiments of the invention herein makes reference to the accompanying drawings, which show the exemplary embodiment by way of illustration and its best mode. While these exemplary embodiments are described in sufficient detail to enable those skilled in the art to practice the invention, it should be understood that other embodiments can be realized and that logical and mechanical changes can be made without departing from the spirit and scope of the invention. Thus, the detailed description herein is presented for purposes of illustration only and not of limitation. For example, the steps recited in any of the method descriptions can be executed in any order and are not limited to the order presented.

For the sake of brevity, conventional data networking, application development and other functional aspects of the systems (and components of the individual operating components of the systems) can not be described in detail herein. Furthermore, the connecting lines shown in the various figures contained herein are intended to represent exemplary functional relationships and/or physical couplings between the various elements. It should be noted that many alternative and/or additional functional relationships and/or physical connections can be present in a practical system.

The invention can be described herein in terms of functional block components, screen shots, optional selections and various processing steps. It should be appreciated that such functional blocks can be realized by any number of hardware and/or software components configured to perform the specified functions. For example, the invention can employ various integrated circuit components (e.g., memory elements, processing elements, logic elements, look-up tables, and the like), which can carry out a variety of functions under the control of one and/or more microprocessors and/or other control devices. Similarly, the software elements of the invention can be implemented with any programming and/or scripting language such as C, C++, Java, COBOL, assembler, PERL, Visual Basic, SQL Stored Procedures, extensible markup language (XML), hypertext markup language (HTML), with the various algorithms being implemented with any combination of data structures, objects, processes, routines and/or other programming elements. Further, it should be noted that the invention can employ any number of conventional techniques for data transmission, signaling, data processing, network control, and the like.

The invention is described herein with reference to block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions can be loaded onto a general purpose computer, special purpose computer, and/or other programmable data processing apparatus to produce a machine, such that the instructions that execute on the computer and/or other programmable data processing apparatus create means for implementing the functions specified in the flowchart block and/or blocks.

These computer program instructions can also be stored in a computer-readable memory that can direct a computer and/or other programmable data processing apparatus to function in a particular manner, such that the instructions stored in the computer-readable memory produce an article of manufacture including instruction means which implement the function specified in the flowchart block and/or blocks. The computer program instructions can also be loaded onto a computer and/or other programmable data processing apparatus to cause a series of operational steps to be performed on the computer and/or other programmable apparatus to produce a computer-implemented process such that the instructions which execute on the computer and/or other programmable apparatus provide steps for implementing the functions specified in the flowchart block and/or blocks. Accordingly, functional blocks of the block diagrams and flowchart illustrations support combinations of means for performing the specified functions, combinations of steps for performing the specified functions, and program instruction means for performing the specified functions.

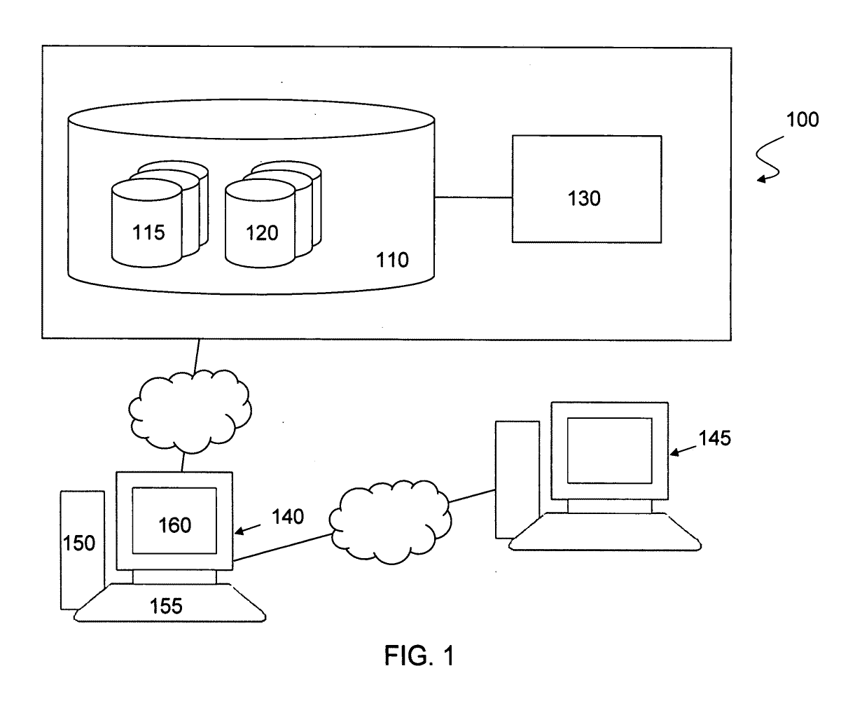

In one embodiment, the invention provides a computerized system and method for analyzing financial data related to professional services. With respect to FIG. 1, system 100 includes one or more databases 110 comprising information relating to client billings and historical client financial data for a plurality of matters associated with a client. A software program 130 communicates with database 110. Databases 110 and program 130 may operate on one or more host computers 140 and/or remote computers 145.

Host computers 140 and remote computers 145 may comprise one and/or more of the following: a host server 150 and/or other computing systems including a processor for processing digital data; a memory coupled to said processor for storing digital data; an input 155 coupled to the processor for inputting data; an application program stored in said memory and accessible by the processor for directing processing of digital data by the processor; a display device 160 coupled to the processor and/or memory for displaying information derived from digital data processed by the processor; and a plurality of databases. As those skilled in the art will appreciate, host computer 140 may include an operating system (e.g., MVS, Windows NT, 95/98/2000/XP, OS2, UNIX, MVS, TPF, Linux, Solaris, MacOS, AIX, etc.) as well as various conventional support software and drivers typically associated with computers.

Host computer 140 may communicate with databases 110 and/or remote computers 145 through a direct connection and/or network connection. As used herein, the term network can include any electronic communications means which incorporates both hardware and software components of such. Communication among the components and/or parties in accordance with the invention can be accomplished through any suitable communication channels, such as, for example, a telephone network (such as a public switched telephone network or Integrated Services Digital Network (ISDN)), an extranet, an intranet, Internet, point-of-interaction device (personal digital assistant, cellular phone, kiosk, etc.), online communications, off-line communications, wireless communications, transponder communications, local area network (LAN), wide area network (WAN), networked and/or linked devices and/or the like. Moreover, the invention can also be implemented using TCP/IP communications protocols, IPX, Appletalk, IP-6, NetBIOS, OSI and/or any number of existing and/or future protocols. If the network is in the nature of a public network, such as the Internet, it can be advantageous to presume the network to be insecure and open to eavesdroppers and, therefore, employ a conventional encryption program. One encryption program that may be used is for example, “Blowfish.” Specific information related to the protocols, standards, and application software utilized in connection with the Internet is generally known to those skilled in the art.

Databases 110 can comprise one or more local, remote or other databases used for information storage and retrieval. Databases 110 can be a graphical, hierarchical, relational, object-oriented or other database. The databases may be configured such that information can be suitably retrieved from the databases and provided to program 130.

System 100 can be used for any type of professional services, such as, legal, accounting, consulting, computer, medical, architecture, etc. One embodiment described herein is adapted for use in connection with a law firm model, in which attorneys, legal assistants and other personnel (“timekeepers”) for whom clients are charge on a per time basis. Timekeepers, as used herein, each have a designated hourly billable rate. As used herein, the term “hourly” refers generally to any increment of time. Services performed by each timekeeper are associated with a particular matter and/or client, which are usually identified by a client and/or matter number or other designation.

The invention described herein contemplates that each timekeeper will record the time spent on a given matter using time and billing software and/or some other means for tracking time spent on matters. One or more timekeepers is given a designated role with respect to the matter. For example, one or more timekeepers can be designated as the “relationship” attorney, one or more timekeepers can be designated as the “responsible” attorney, and one or more timekeepers may be undesignated or designated as “working attorney” or “professional” timekeepers. Relationship attorney refers generally to the attorney having the overall responsibility for the relationship with the client. Responsible attorney refers generally to the attorney having overall responsibility for the particular matter. Working attorney or professional refers to other timekeepers who bill time to the matter. A single timekeeper may have more than one role for the matter. These roles are used to compile statistics related to each timekeeper. For example, the firm may compile statistics regarding the dollar amount of business for which a timekeeper is designated as “relationship,” “responsible,” and/or “professional” during a given year. Such statistics are often used to determine compensation or promotion. Timekeepers may also be designated as either “equity” or “non-equity” professionals. In a typical law firm, equity partners are those attorneys who have an ownership interest in the firm and share in the firm's profits and losses.

Database 110 is populated with data extracted from the firm's accounting database 115 and human resources (HR) database 120. Accounting database 115 contains information, including, but not limited to financial data relating to the firm's collections, hours billed, billing rates, matter/timekeeper roles, general ledger costs, and the like. HR database 120 contains information including, but not limited to, data relating to personnel, locations, payroll, equity partner status, secretary/lawyer allocations, equity partner compensation and the like. Data is extracted from databases 115 and 120 to build system database 110. Histories of the timekeepers are created so that for any given moment of time in a timekeeper's tenure, the title, location, and department are recorded with associated date ranges. Histories of the matters are created so that for any given moment of time, the timekeeper's department, location, and role are recorded with date ranges. The financial data is then aggregated against the timekeeper's roles. The person who occupies each role for each matter is given one entry in the table, thus multiplying the base financial data times the number of roles. When any of a matter's roles have multiple timekeepers sharing that role, the financial credit is multiplied by that timekeeper's allocated percentage share of credit for that role.

The invention contemplates that accounting database 115 and/or HR database 120 are populated using data from one or more accounting and/or human resource software systems known in the art. For example, accounting systems including, but are not limited to Elite CMS, Juris, Keystone, and the like, can be used to collect and tabulate billing information, collection information, hours worked, costs, and the like and store this information in accounting database 115 associated with the system. Similarly, human resource systems including, but not limited to Oracle Peoplesoft, SAP, Microsoft Dynamics AX and other similar enterprise resource planning tools can be used to generate and store information relating to payroll, staffing, personnel, compensation, overhead and the like and store this information in HR database 120. The invention further contemplates the use of one or more docketing systems, timekeeping systems and the like that can be configured to store information in accounting database 115, HR database 120 and/or any other type of database in communication with system 100.

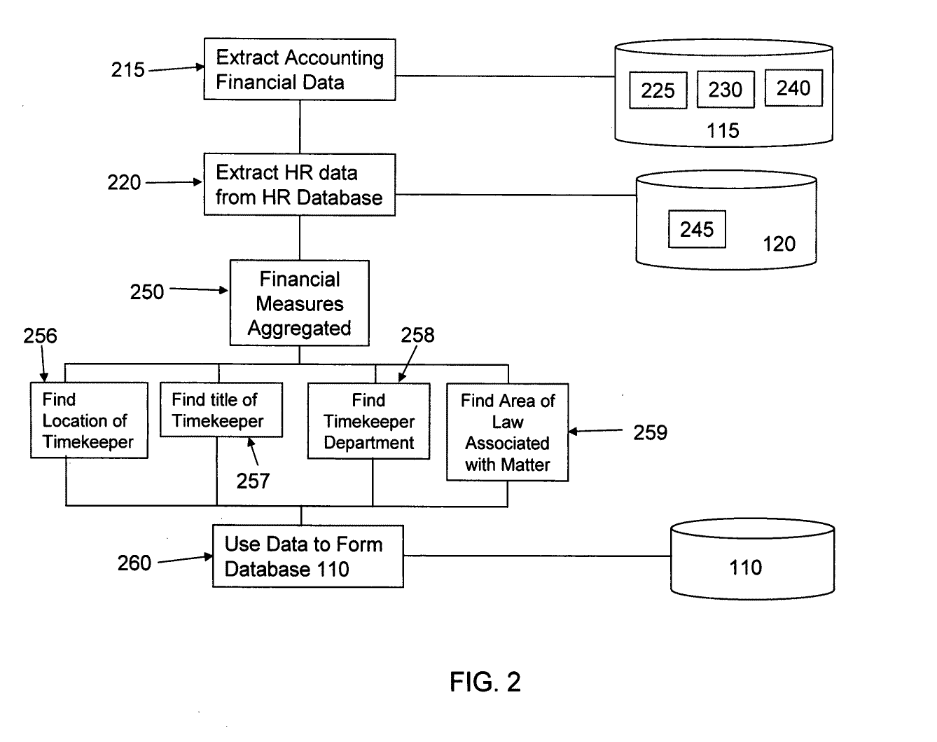

FIG. 2 is a flow chart illustrating the extraction and aggregation of data to build system database 110. Accounting financial data is extracted from accounting database 115 (FIG. 1) (step 215). Accounting financial data includes, but is not limited to, a client history data file 225, a matter history data file 230, a timekeeper/mater role history data file, and a financial measures data file 240. HR data is extracted from HR database 120 (FIG. 1) (step 220). In one embodiment, HR data can comprise a timekeeper history data file 245. At step 250, financial measures are aggregated against timekeeper/matter role history to generate financial data associated with each timekeeper in each role for each matter. Each record is keyed to a timekeeper's history record to assemble a data record associated with each timekeeper comprising the following information for the time at which the matter was worked on by the timekeeper: (i) the location of the timekeeper (step 256), (ii) the title of the timekeeper (step 257) (e.g., equity partner, non-equity partner, associate, legal assistant), (iii) the timekeeper's department or group (step 258), and (iv) the area of the law and location associated with the matter (step 259). This aggregated data is used to form system database 110 (step 260).

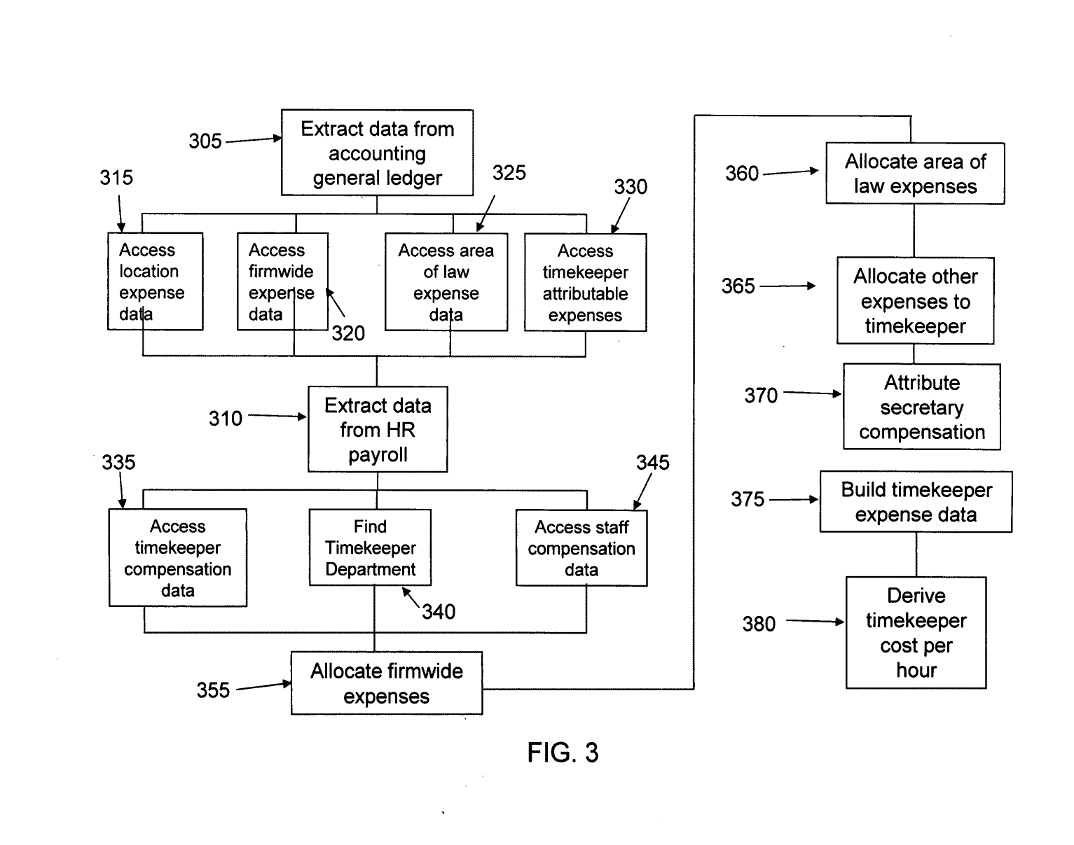

One of the advantages of the system is that it determines each timekeeper's cost per hour and utilizes this cost in other calculations useful in analyzing profitability discussed below. FIG. 3 is a flow chart illustrating a method for determining timekeeper cost per hour. Various cost data used to calculate time keeper cost per hour may be extracted from two data sources: accounting general ledger data 305 and HR payroll data 310. Accounting general ledger data 305 is extracted from accounting database 115 (FIG. 1). Accounting general ledger data 305 includes location expense data 315, firmwide expense data 320, area of law expense data 325, and timekeeper attributable expenses 330. HR payroll data 310 is extracted from HR database 120. HR payroll data 310 includes timekeeper compensation data 335, secretarial compensation data 340 and staff compensation data 345. Each of these expenses can be allocated to each timekeeper to determine the cost associated with each timekeeper. In the illustrated embodiment, the firm has offices in multiple locations having varying associated costs. Total staff compensation expenses 345 for each location are combined with other location expenses 315 (e.g., rent, office supplies, utilities, parking, etc.) to determine the total expenses associated with each location. At step 350 the costs associated with each location are allocated to each timekeeper who occupies the location. Expenses associated with offices without timekeepers may be included within a firmwide overhead expense category. At step 355 firmwide expenses are allocated to each timekeeper on a weighted average full-time equivalent (FTE) basis. At 360, area of the law expenses are allocated to the timekeepers who practice in that area of the law. Other expenses, like bar dues, are keyed to a particular timekeeper. These expenses are allocated to the associated timekeeper at step 365. At step 370, the timekeeper's compensation and the compensation of the timekeeper's secretary (or portion thereof if the timekeeper shares a secretary with another timekeeper) is attributed to each timekeeper. All of this allocated data is used to build timekeeper expense data 375. At step 380, the sum of each timekeeper's expenses is divided by the timekeeper's minimum hours to derive timekeeper cost per hour data.

Software program 130 preferably runs on a server accessible to multiple persons in the firm to revise and/or analyze financial and/or performance data.

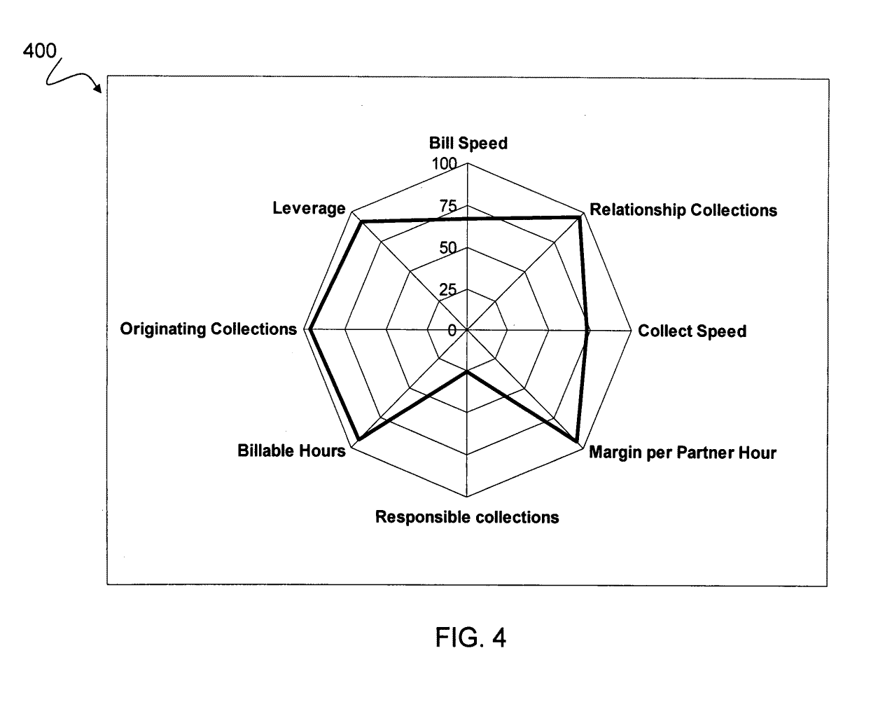

With respect to an exemplary embodiment illustrated in FIG. 4, an octagon display 400 represents the transformation of information gathered from databases 110 and transformed using software program 130. Exemplary octagon 400 is configured to display eight or more attorney metrics in a single location. Octagon 400 assimilates the eight or more measures into a single shape, the bounds of which are determined by the relative strength of each of the eight measures. While octagon 400 is illustrated as an eight sided figure to assimilate eight sets of data, the invention contemplates using different shapes to assimilate data for a different number of measures. For example, a hexagon may be used to assimilate data for six measures, a pentagon for five measures, a heptagon for seven measures, and so forth.

Each of the measures in octagon 400 is expressed as a percentile of the overall population to which the report applies. For example, in a report delivered to partners, an 80% indication on, for example, billing speed, means that partner bills faster than 80% of all other partners. Octagon 400 is configured to display a numerical value for each percentile score, and it also extends the chart's shape to the correct place in the appropriate quartile band of the chart. An 80^{th} percentile score in billing speed would thus extend the shape slightly into the fourth quartile band of the chart at the billing speed axis.

Software program 130 can be configured to facilitate the transformation of data into octagon 400 by accessing information from one or more databases 110. For example, software 130 can be coded to access accounting database 105 and pull information relating to Attorney X's (1) Relationship, Responsible, and Originating Collections; (2) Billable Hours; (3) Leverage; (4) bill and collection speed; and (5) margin per hour.

As Used herein, the phrase “relationship, responsible and originating collections” refers to the amount collected per type of attorney/client role. That is, an attorney may be assigned the role of Relationship attorney, Responsible attorney and/or Originating attorney. When a client is invoiced for legal services, the invoice payments reflect the various assigned roles to facilitate tracking invoice payments, client histories, attorney responsibilities, and the like. As described above, and/or in addition to, the relationship attorney is generally the attorney who prepares the bill for the client. Because the relationship attorney generally has a close tie to the client, the relationship attorney receives a certain amount of credit (whether monetary or otherwise), for all the billing for the client. As described above, and/or in addition to, the responsible attorney is generally the attorney having overall responsibility for a specific matter for the client. For example, if Client Y needs both tax advice and real estate advice, responsible attorney X may be assigned to the client for the tax advice, while responsible attorney Z may be assigned to the client for the real estate advice. In other circumstances, the same responsible attorney may handle both matters. The originating attorney is the attorney through which a matter originated. For example, if Client Y contacts attorney A for tax advice, attorney A is the originating attorney, even though attorney X may be assigned to provide the tax advice for the client. One lawyer may be assigned the role of any or all of relationship, responsible and originating attorney. Moreover, more than one attorney can be assigned to any of the roles. While the present embodiment contemplates three attorney roles, any number of roles can be assigned depending on the situation.

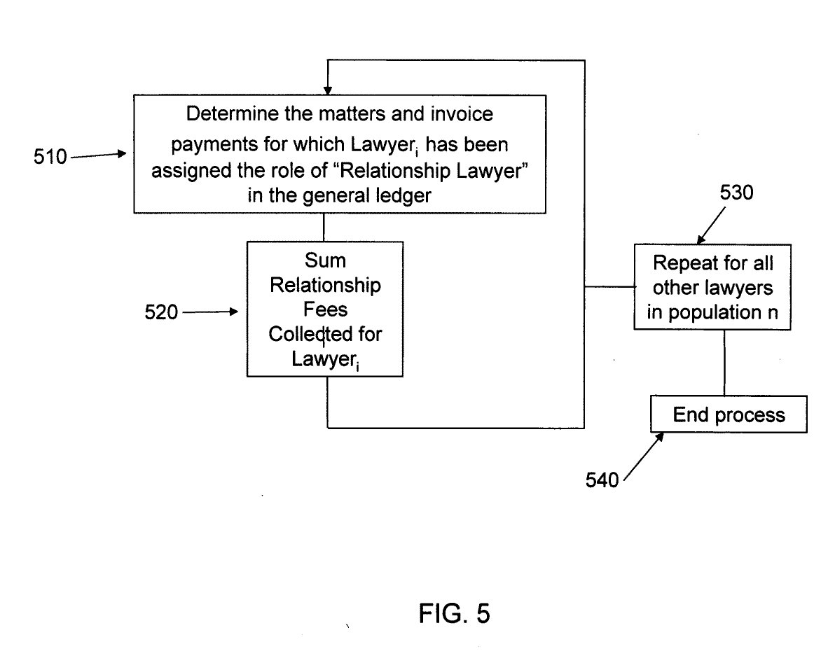

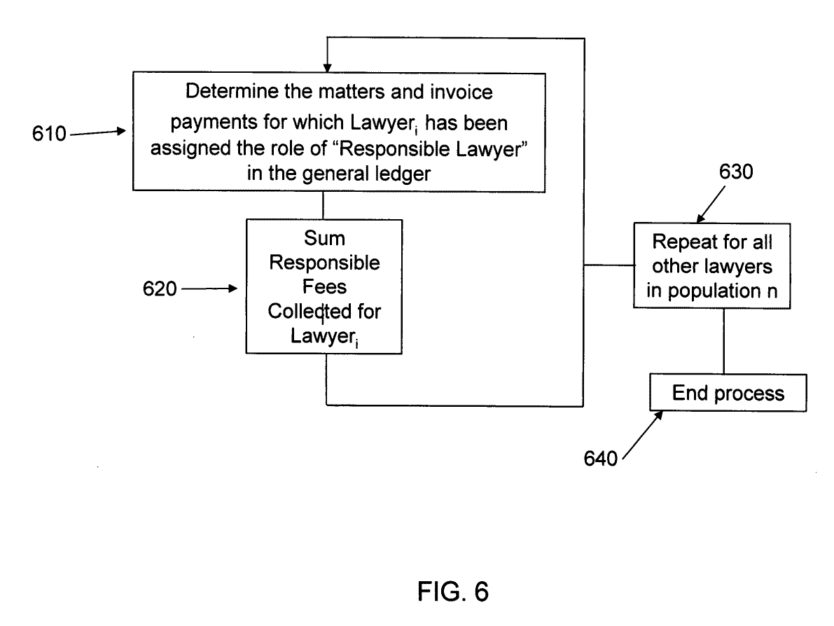

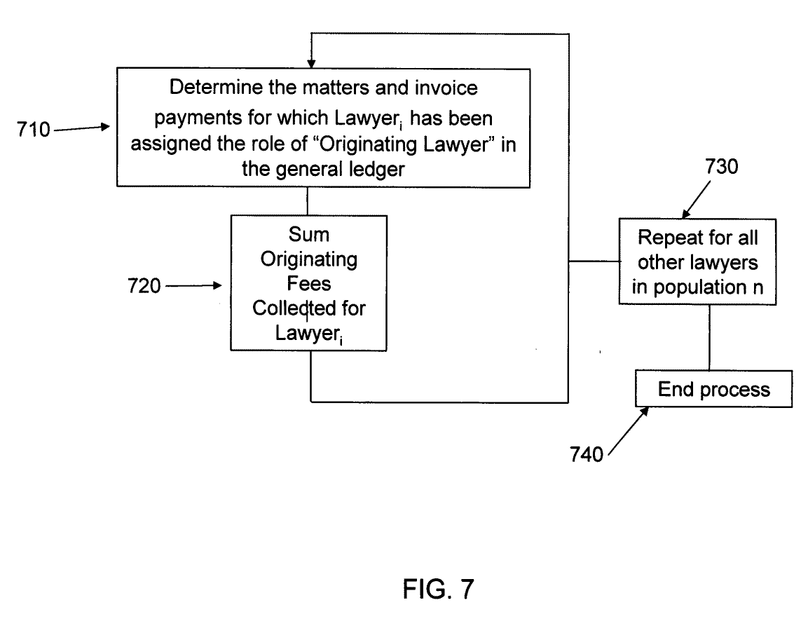

Exemplary flow charts for calculating Relationship Collections, Responsible Collections and Originating Collections are illustrated in FIGS. 5, 6 and 7, respectively: For example, in order to calculate Relationship Collections 500, software 130 first determines the matters and invoice payments for which Lawyerᵢ has been assigned the role of “Relationship Lawyer” in the general ledger (step 510). Software 130 then sums the collections for those matters in which Lawyerᵢ has been assigned the role of “Relationship Lawyer” (step 520). Software 130 repeats steps 510 and 520 for each lawyer in the metric population n (i.e., for Lawyerᵢ . . . Lawyerₒ (step 530). Once the Relationship Collections has been calculated for each lawyer in the metric population, software 130 can terminate the process (step 540).

Similarly, in order to calculate Responsible Collections 600 and Originating Collections 700, software 130 uses similar processes. For example, for Responsible Collections 600, software 130 first determines the matters and invoice payments for which lawyer n has been assigned the role of “Responsible Lawyer” in the general ledger (step 610). Software 130 then sums the collections for those matters in which Lawyerᵢ has been assigned the role of “Responsible Lawyer” (step 620). Likewise, for Originating Collections 700, software 130 first determines the matters and invoice payments for which Lawyerᵢ has been assigned the role of “Originating Lawyer” in the general ledger (step 710). Software 130 then sums the collections for those matters in which Lawyerᵢ has been assigned the role of “Originating Lawyer” (step 720). For both Responsible Collections and Originating Collections, software 130 repeats steps 610, 710 and 620, 720 for each lawyer in the metric population n (step 630, 640). Once the Responsible Collections and Originating Collections have been calculated for each lawyer in the metric population, software 130 can terminate the process (step 640, 740).

Octagon 400 is configured to show the percentage overlap between Relationship Collections and Origination Collections below the Originating Collections label. A low degree of overlap indicates that as a relationship lawyer, a professional is encouraging other lawyers to originate new business. The percentage overlap between Relationship Collections and Responsible Collections on octagon 400 is shown below the responsible collections label. A low degree of overlap indicates that as a relationship lawyer, a professional is encouraging other lawyers to take on responsibility for managing matters.

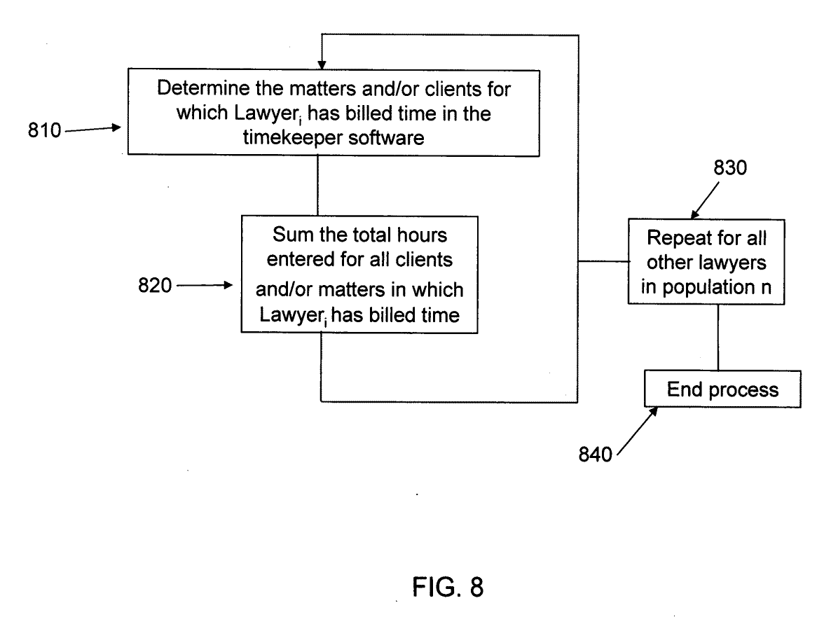

As used herein, the phrase “billable hours” refers to the sum of the amount of time entered into the time entry table of the accounting system by a timekeeper on matters designated as billable to a client. An exemplary flowchart illustrating a method for calculating billable hours, in accordance with the invention, is illustrated in FIG. 8. For example, each client may be assigned a separate billing number for timekeeping purposes and this number is maintained in database 115. Alternatively and/or in addition, each client may have one or more matter numbers assigned to it. The matter numbers may relate to specific services that are being provided (i.e. drafting contract between Client Y and Third-Party C) or the matter numbers may relate to general services (i.e., general tax advice). Further, each lawyer may track his time billed to each particular client and/or matter, by entering a client and/or matter number into the timekeeping software used on system 100, as described herein. The lawyer also enters in a discrete amount of time to be associated with the client and/or matter. For example, a lawyer who spends a half hour working on Matter X for Client A, may enter 0.5 hours of time into the timekeeping software and associate that time with Matter X and/or Client A. The total hours billed to each client and/or matter are stored in accounting database 115. Alternatively, and/or in addition, the total hours a lawyer has billed to all matters and/or clients may additionally be stored in accounting database 115.

In order to calculate Billable Hours 800, software 130 first determines the matters and/or clients for whom lawyer has billed time in the timekeeper software (step 810). Software 130 then sums the total hours entered for all clients and/or matters in which Lawyerᵢ has billed time (step 820). Software 130 repeats steps 810 and 820 for each lawyer in the metric population n (i.e., for Lawyerᵢ . . . Lawyerₙ) (step 530). Once the Billable Hours has been calculated for each lawyer in the metric population, software 130 can terminate the process (step 840).

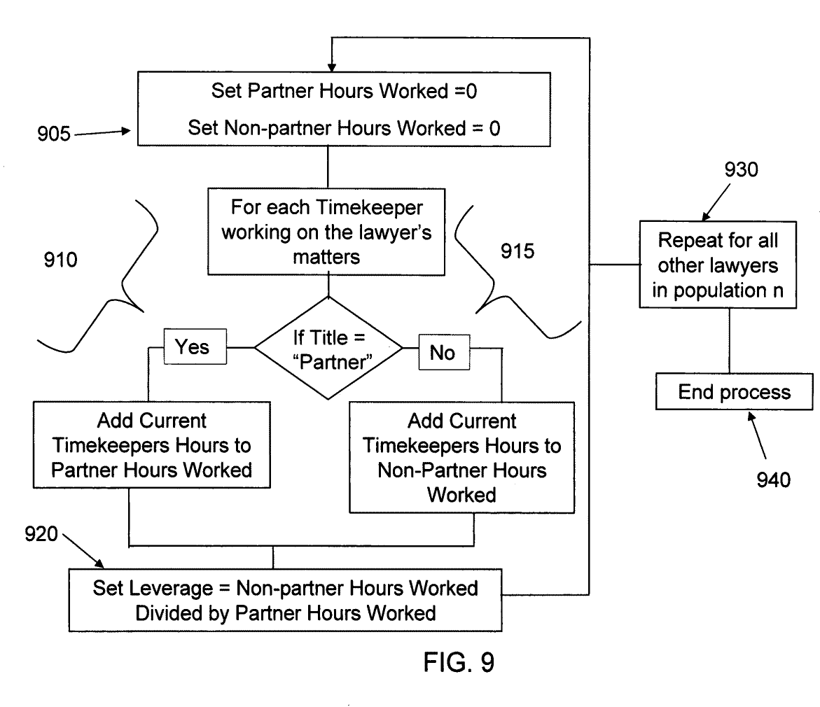

Leverage, relates to the ratio between partner hours and all other fee earner hours for the work reflected in the relationship billings. With respect to an exemplary flow chart illustrated in FIG. 9, leverage 900 can also be calculated by software 130 (again, using information stored on database 115). Initially, the number of partner and non-partner hours worked for matters for which a given Lawyerᵢ is a Relationship lawyer are set to zero (step 805). Software 130 is configured to first calculate the sum of partner hours of all timekeepers billed to all matters for which a given Lawyerᵢ is a Relationship lawyer (step 910). Software 130 additionally is configured to calculate the sum of non-partner hours of all timekeepers billed to all matters for which a given Lawyerᵢ is a Relationship lawyer (step 915). Software 130 is configured to then take the total non-partner hours billed to the matters and divide this amount by the total partner hours billed to determine the leverage amount (step 920). Software 130 repeats steps 910, 915 and 920 for each lawyer in the metric population n (i.e., for Lawyerᵢ . . . Lawyerₙ) (step 930). Once the leverage amount has been calculated for each lawyer in the metric population, software 130 can terminate the process (step 940).

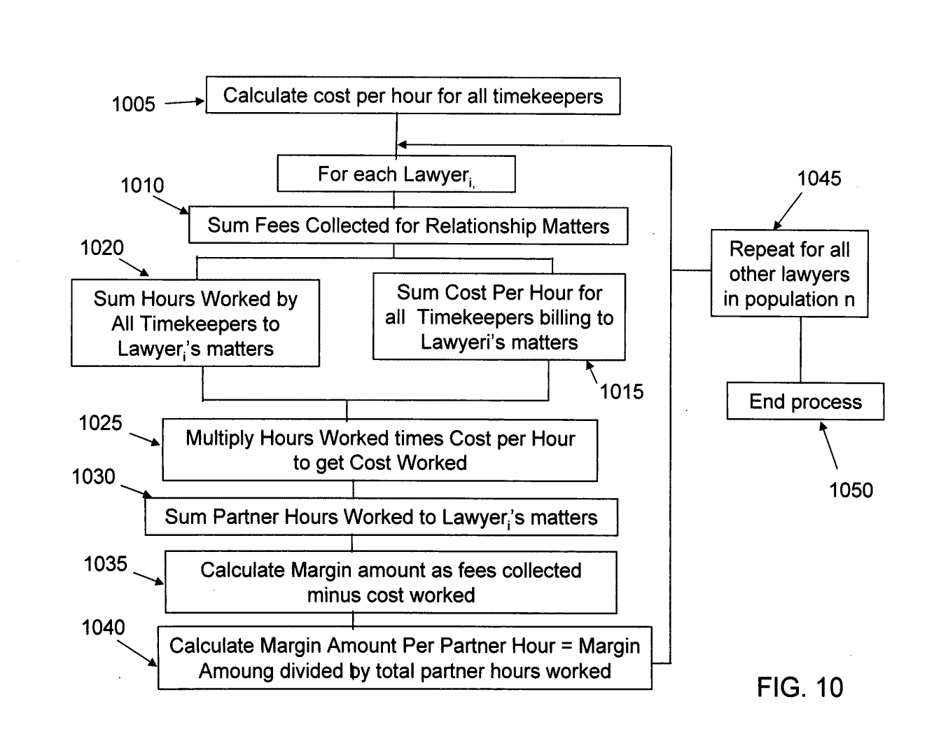

The margin per partner hour is a measure of the profitability of the engagements for which relationship collections are shown. That is, it shows the profitability of all matters for which a partner is a relationship lawyer on a percentile basis in comparison to that of all other partners who are relationship lawyers. With respect to an exemplary flow chart illustrated in FIG. 10, margin per partner hour 1000 can also be calculated by software 130. The margin per partner hour is calculated by first determining a cost per hour for every timekeeper using data from database 115 (step 1005). Next, for each Lawyerᵢ, software 130 is configured to sum the total fees collected (step 1010), the total hours worked by all timekeepers to Lawyerᵢ's matters (step 1015) and costs per hour (step 1020) for each timekeeper working on Lawyerᵢ's matters (that is, those matters for which Lawyerᵢ is the Relationship lawyer). Software 130 can be configured to calculate the costs worked by multiplying the hours worked times the cost per hour for each timekeeper working on a Relationship lawyer's matters (step 1025). Software 130 is then configured to sum the total partner hours worked (step 1030). Once these amounts are tallied, the costs worked are subtracted from the fees collected to arrive at a net margin amount (step 1035). The net margin amount is then divided by the total partner hours worked (step 1030) to determine the margin per partner hour (step 1040). Software 130 repeats steps 1010, 1015, 1020, 1025, 1030, 1035 and 1040 for each lawyer in the metric population n (i.e., for Lawyerᵢ . . . Lawyerₙ) (step 1045). Once the margin per partner amount has been calculated for each lawyer in the metric population, software 130 can terminate the process (step 1050).

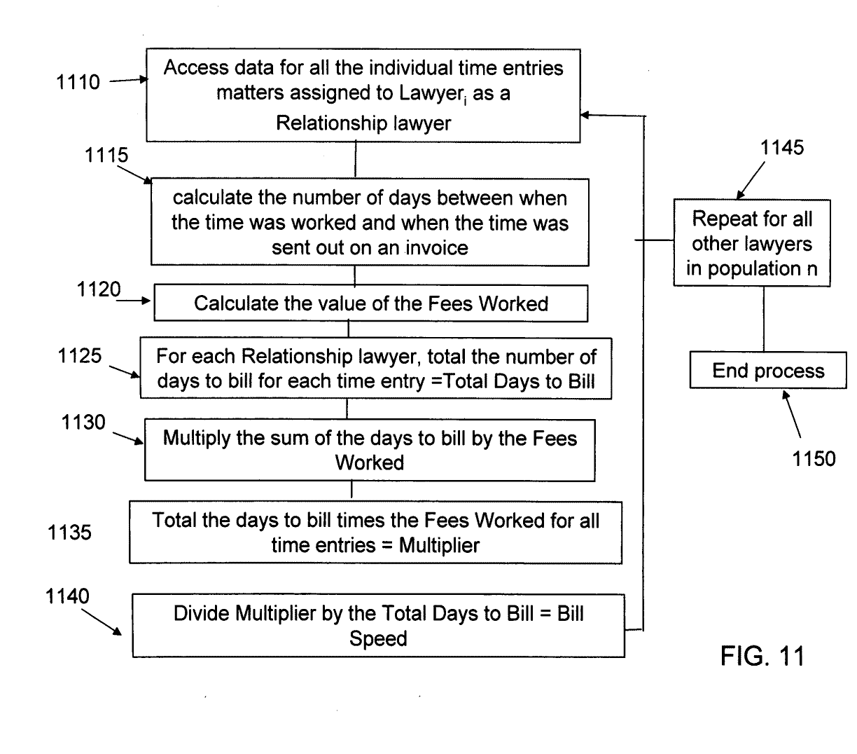

With respect to an exemplary flow chart illustrated in FIG. 11, software 130 and/or software on accounting database 115 can be used to calculate the average time between when the work reflected in relationship billings is performed and when it is billed. For each Lawyerᵢ that is in a Relationship lawyer role, software 130 and/or software on accounting database 115 accesses data for all the individual time entries matters assigned to Lawyerᵢ as a Relationship lawyer (step 1110) and calculates the number of days between when the work was performed and when the associated fees were included in an invoice delivered to the client (step 1115). In another embodiment, software 130 may calculate the number of days between when the associated fees were included in an invoice and when the invoice was delivered to the client. In yet another embodiment, software 130 may calculate the number of days between when the work performed was released to accounting database 115 and when an invoice reflecting the work performed was delivered to a client.

In order to determine a Relationship lawyer's bill speed, software 130 and/or software on accounting database 115 also calculates the value of the fees worked (step 1120). For each Relationship lawyer, the number of days to bill for each time entry is totaled (step 1125). The total days to bill is then multiplied by the value of the fees worked (step 1130) and then this value summed (step 1135) to create a multiplier for a weighted average. Finally, the multiplier amount (that is, sum of days to billed times value of fees worked from step 1135) is divided by the value of the fees worked (step 1140) to arrive at a weighted average number of days that it takes a Relationship lawyer to bill out time that was worked (that is, the bill speed). Software 130 repeats steps 1110, 1115, 1120, 1125, 1130, 1135 and 1140 for each lawyer in the metric population n (i.e., for Lawyerᵢ . . . Lawyerₙ) (step 1145). Once the bill speed has been calculated for each lawyer in the metric population, software 130 can terminate the process (step 1150).

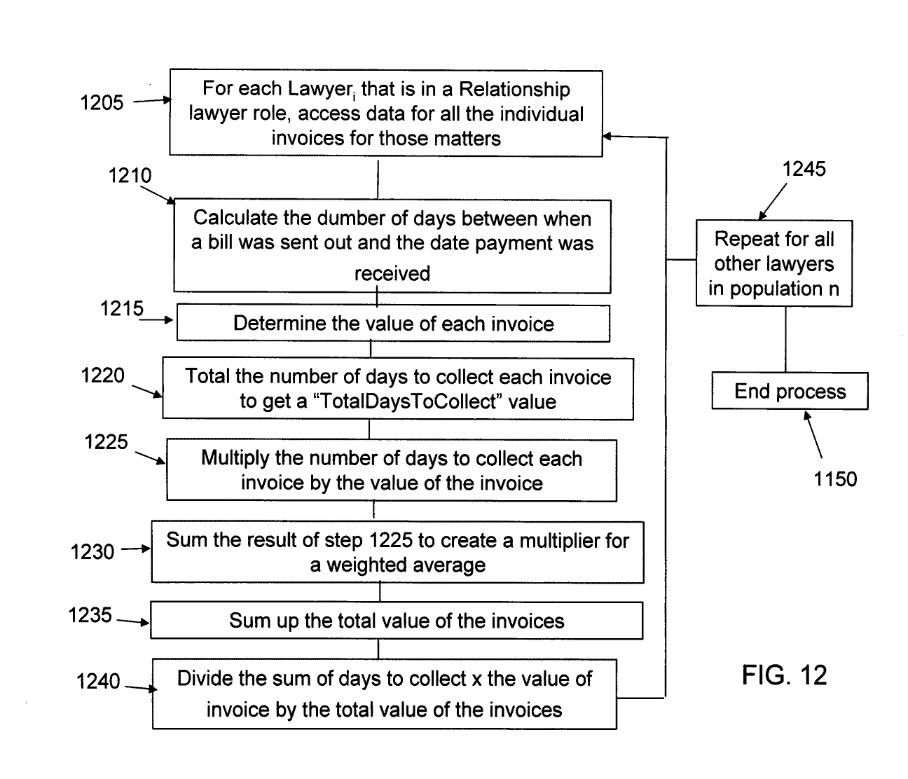

With respect to an exemplary flow chart illustrated in FIG. 12, software 130 and/or software on accounting database 115 can be used to calculate the collection speed in accordance with the invention. The Collection Speed is based on the average time between when the work reflected in relationship collections is billed and when it is paid by clients. For each Lawyerᵢ that is in a relationship lawyer role, software 130 and/or software on accounting database 115 accesses data for all the individual invoices for those matters (step 1205) to calculate the dumber of days between when a bill was sent out and the date payment was received (step 1210). Software 130 and/or software on accounting database 105 can also be configured to determine the value of each invoice (step 1215). For each Lawyerᵢ that is in a relationship lawyer role, the number of days to collect each invoice is totaled to get a “TotalDaysToCollect” value (step 1220). The number of days to collect each invoice is then multiplied by the value of the invoice (step 1225), and this value is summed for all invoices to create a multiplier for a weighted average (step 1230). The total value of the invoices is also summed up (step 1235). Finally the multiplier amount (sum of days to collect times value of invoice) is divided by the total value of the invoices (step 1240) to arrive at a weighted average number of days that it takes a Relationship lawyer to collect on invoices. Software 130 repeats steps 1205, 1210, 1215, 1220, 1225, 1230, 1235 and 1240 for each lawyer in the metric population n (i.e., for Lawyerᵢ . . . Lawyerₙ) (step 1045). Once the collection speed has been calculated for each lawyer in the metric population, software 130 can terminate the process (step 1250).

Octagon 400 can additionally be configured to display a blended rate and/or and effective rate. Software 130 can be used to calculate the blended rate by tabulating all the relationship billing fees generating at an average firm rate or “One Rate,” and dividing the fees over the total hours worked. Software 130 can be used to calculate the effective rate by summing the total relationship collection fees collected and dividing the fees over the total hours collected.

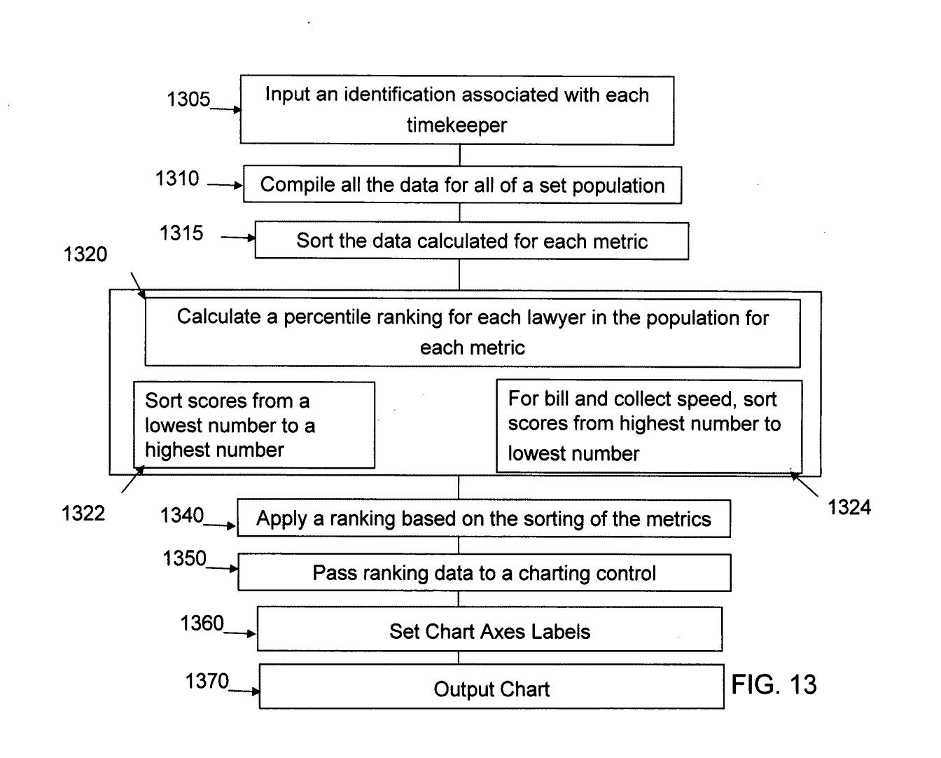

Once the individual metrics are determined for all lawyers in a population (e.g., all partners) and with reference to an exemplary flow chart illustrated in FIG. 13, software 130 and/or software on accounting database 115 compiles the data from each timekeeper in the population by first inputting an identification associated with that timekeeper (step 1305). For example, an employee number, employee name, etc. may be used. Software 130 and/or software on accounting database 115 compiles all the data for all of a set population (i.e., for all Partners) over a certain time period (i.e., one year) (step 1310). Software 130 and/or software on accounting database 115 then sorts the data calculated for each metric (i.e., bill speed, collection speed, billable hours, relationship collections, responsible collections, originating collections, leverage, and margin per partner hour) (step 1315). Software 130 and/or software on accounting database 115 calculates a percentile ranking for each lawyer in the population for each metric (step 1320). For example, for most metrics, scores are sorted from a lowest number to a highest number (step 1322), however, for bill and collect speed, the sorting is actually reversed since the least number of days results in the highest ranking (step 1324).

Software 130 and/or software on accounting database 115 then applies a ranking based on the sorting of the metrics (step 1340). For example, the lawyer with the slowest bill speed would be assigned a value of 0 percent for that metric. The percent ranking for every other data value is calculated based on the row number for that specific number. For example, if there are s attorneys in the population, than there will be s total rows of data. For example, in one exemplary embodiment, the SQL is:

```
  case when row_number( ) over (order by relationshipfeesCollected) = 1
then 0
    when row_number( ) over (order by relationshipfeesCollected) = 2
then 1.00 / (@count − 1.00)
    else (row_number( ) over (order by relationshipfeesCollected) *
(1.00 / (@count − 1.00)) − (1.00 / (@count − 1.00))) end
```

Software 130 then passes this data to a charting control that is set to display a polygon-shaped radar chart based on the number of metrics to be charted (step 1350). Software 130 and/or the charting control sets the y-axis is set to display from 0 to 100 in order to accurately reflect the percentile nature of the data and the x-axis is set to display the name of the metric for each point on the polygon (step 1360). The data is plotted on the radar chart and connecting lines are constructed between each point (step 1370). In one embodiment, the area contained within the shape drawn is filled in with color, however color is optional. A border may also applied along the lines between the data points to emphasize the actual data points. The resultant chart creates a picture of the data within the polygon-shaped radar chart, such as, for example an exemplary octagon chart in accordance with the invention, as illustrated in FIG. 4.

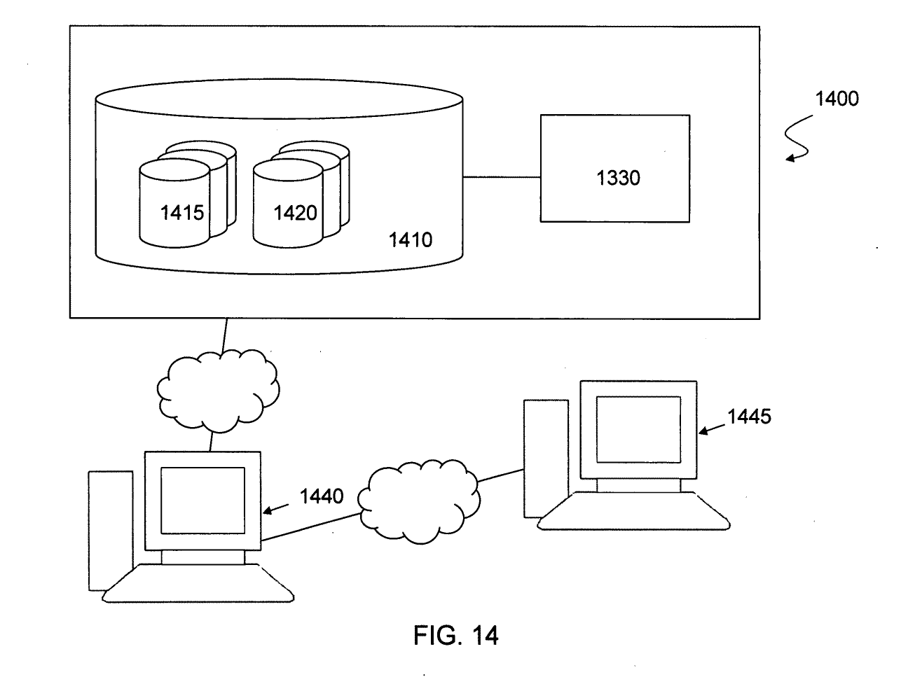

In another exemplary embodiment in accordance with the invention, system 100 can be used to provide general representations of relative performance with respect to the assimilation of sets of key performance measures. For example, system 100 can be used to determine relative performance measures of professional sports players, for example professional baseball players. For example, with respect to FIG. 14, system 1400 can contain one or more databases 1415, 1420 containing information regarding one or more baseball and player statistics. For example, database 1415 can store information regarding runs batted in (RBIs), errors, hits, strikeouts, walks, runs created, batting wins, offensive win percentage, batting average, slugging percentage, total bases and homeruns scored by each active and/or inactive professional baseball players. Database 1420 can store historical information about previous major league players and/or statistics from previous years. Software 1430 can be configured to sum one or more statistics for a given population of baseball players (i.e., American League players, National League players, St. Louis Cardinals players, and the like), over a given time period.

Similarly to system 100, databases 1410 and program 1430 operate on one or more host computers 1440 and/or remote computers 1445. The databases 1410, host computers 1440, and remote computers 1445 are configured similarly to the databases and computers described herein.

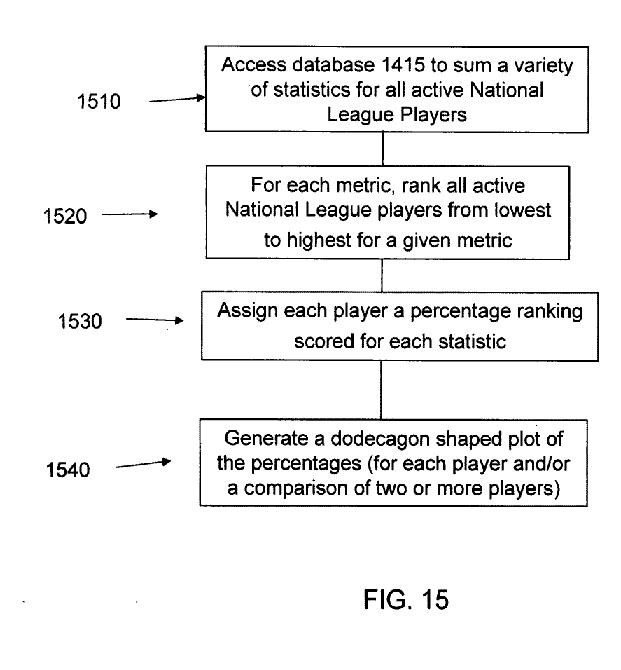

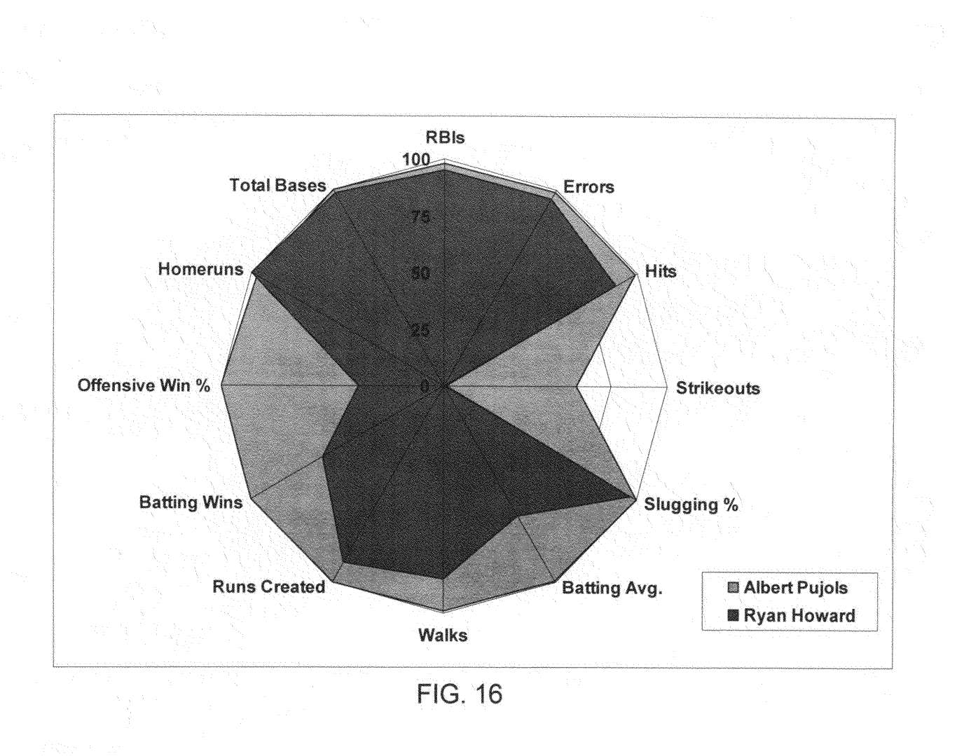

For example, and with reference to an exemplary flow chart illustrated in FIG. 15, in one exemplary embodiment, software 1430 is configured to access database 1415 to sum the following statistics for all active National League Players over a season: RBIs, errors, hits, strikeouts, walks, runs created, batting wins, offensive win percentage, batting average, slugging percentage, total bases and homeruns scored (step 1510). Next, for each metric, software 1430 ranks all active National League players from lowest to highest for a given metric (step 1520). For the following statistics, software 1430 this ranking will range from lowest number to highest number: RBIs, hits, walks, runs created, batting wins, offensive win percentage, batting average, slugging percentage, total bases and homeruns scored. However, for errors and strikeouts, the ranking will go from highest number to lowest number.

Once software 1430 has finished ranking the players for each given statistic, software 1430 will assign each player a percentage ranking scored for each statistic (step 1530). For example, if Albert Pujols has the highest slugging percentage in a season, he will be assigned a percentage of 100% for this metric. Similarly, if Ryan Howard ranks the seventh highest slugging percentage out of 200 National League Players (i.e., non-pitchers that have played 70 or more games), he will be assigned a percentage of 96.5%. Software 1430 than continues this percentage assigning step for each remaining statistic.

Software 1430 can then use the percentages calculated in step 1540 to generate a dodecagon shaped plot of the percentages (step 1550), as illustrated in an exemplary dodecagon plot illustrated in FIG. 16. The dodecagon of each player can therefore be used to better assess the player and compare him to other players. Such a visual comparison can be used, for example, in determining whether a player should be voted an MVP of the league.

As will be appreciated by one of ordinary skill in the art, the invention can be embodied as a method, a data processing system, a device for data processing, and/or a computer program product. Accordingly, the invention can take the form of an entirely software embodiment, an entirely hardware embodiment, and/or an embodiment combining aspects of both software and hardware. Furthermore, the invention can take the form of a computer program product on a computer-readable storage medium having computer-readable program code means embodied in the storage medium. Any suitable computer-readable storage medium can be utilized, including hard disks, CD-ROM, optical storage devices, magnetic storage devices, and/or the like.

The invention has been described above with reference to various exemplary embodiments. However, those skilled in the art will recognize that changes in modifications may be made to the exemplary embodiments without departing from the scope of the invention. As used herein, the terms “comprises,” “comprising,” and/or any other variation thereof, are intended to cover a non-exclusive inclusion, such that a process, method, article, and/or apparatus that comprises a list of elements does not include only those elements but may include other elements not expressly listed and/or inherent to such process, method, article, and/or apparatus. Further, no element described herein is required for the practice of the invention unless expressly described as “essential” and/or “critical.”

What is claimed:

1. A method for generating metrics relating to professionals' performance, comprising;
collecting accounting data in an accounting database relating to at least one of: a firm's collections, total hours billed, hours billed per professional, professional billing rates, matter/timekeeper roles, and general ledger costs;
collecting human resource data in a human resource database relating to at least one of: personnel, locations, payroll, equity partner status, secretary per professional allocations, and equity partner compensation; and
using a computer to execute a software program to:
(a) tabulate data from the accounting database and the human resource database using a tabulation software program executing on the computer;
(b) generate metrics relating to a professional's performance based upon the tabulated data; and
(c) normalize the metrics over a total firm population.

2. The method of claim 1, further comprising presenting the metrics into a radar chart.

3. The method of claim 1, wherein the professional is at least one of a lawyer, accountant, engineer and consultant.

4. A computer readable medium storing computer instructions for generating metrics relating to a professional's performance, comprising;
collecting accounting data in an accounting database relating to at least one of: a firm's collections, total hours billed, hours billed per professional, professional billing rates, matter/timekeeper roles, and general ledger costs;
collecting human resource data in a human resource database relating to at least one of: personnel, locations, payroll, equity partner status, secretary per professional allocations, and equity partner compensation; and
executing a software program to:
(a) tabulate data from the accounting database and the human resource database using a tabulation software program executing on the computer;
(b) generate metrics relating to a professional's performance based upon the tabulated data; and
(c) normalize the metrics over a total firm population.

5. A system for generating metrics relating to a professional's performance, the system comprising:
An accounting database comprising financial data relating to a firm;
A human resource database comprising data relating to the firm's personnel;
a software program configured to extract financial data from the accounting database and personnel data from the human resource database, categorize a professional's performance based on the financial and human resource data, and generate metrics relating to the professional's performance based on the categorized data.

6. The system of claim 5, wherein the software program is further programmed to generate a radar chart of the metrics.

7. A method for generating metrics relating to baseball players, comprising;
collecting in a database baseball statistics relating to one or more of batting statistics, fielding statistics, and pitching statistics for a total baseball population;
using a computer to execute a software program to:
(a) rank each player in the total population for each category of one or more of batting statistics, fielding statistics, and pitching statistics for a total baseball population;
(b) normalize the rankings over a total baseball population to obtain a percentile ranking; and
(c) generate a radar chart of the percentile rankings for each category of one or more of batting statistics, fielding statistics, and pitching statistics for a baseball player.

8. The method of claim 7, further comprising using the computer to generate a radar chart of the percentile rankings for each category of one or more of batting statistics, fielding statistics, and pitching statistics for a second baseball player.

9. The method of claim 8, further comprising displaying the radar charts of the baseball player and the second baseball player in the same radar chart.

10. A method for generating a representation of relative performance measurements, comprising;
collecting in a database statistics for a population of people relating to one or more performance measurements;
using a computer to execute a software program to:
(a) rank each person in the total population for each category of one or more of performance measurements;
(b) normalize the rankings over the total population to obtain a percentile ranking; and
(c) generate a radar chart of the percentile rankings for each category of one or more performance measurements for a first person.

11. The method of claim 10, further comprising using the computer to generate a radar chart of the percentile rankings for each category of one or more performance measurements for a second person.

12. The method of claim 11, further comprising displaying the radar charts of the first person and the second person in the same radar chart.

13. The method of claim 10, wherein the performance measurements include at least one of: batting statistics, fielding statistics, pitching statistics, player statistics, firm's collections, total hours billed, hours billed per professional, professional billing rates, matter/timekeeper roles, and general ledger costs.
